(19) United States
(12) Patent Application Publication
(10) Pub. No.: US 2013/0004316 A1
(43) Pub. Date: Jan. 3, 2013

(54) MULTI-PIECE CENTRIFUGAL IMPELLERS AND METHODS FOR THE MANUFACTURE THEREOF

(75) Inventors: Mark Matwey, Phoenix, AZ (US); Srinivas Chunduru, Chandler, AZ (US); David K. Jan, Fountain Hills, AZ (US); David Hanley, Scottsdale, AZ (US)

(73) Assignee: HONEYWELL INTERNATIONAL INC., Morristown, NJ (US)

(21) Appl. No.: 13/171,158

(22) Filed: Jun. 28, 2011

(51) Int. Cl. F01D 5/14; B23P 15/04

(52) U.S. Cl. 416/198 A; 29/889.7

(57) ABSTRACT

Embodiments of a multi-piece centrifugal impeller are provided, as are embodiments of a method for manufacturing a multi-piece centrifugal impeller. In one embodiment, the centrifugal impeller includes an inducer piece and an exducer piece. The inducer piece includes, in turn, an inducer hub and a plurality of forward blade segments, which extend radially outward from the inducer hub. The exducer piece includes an exducer hub, which is positioned axially adjacent the inducer hub, and a plurality of aft blade segments, which extending outward from the exducer hub. The plurality of aft blade segments interlock with the plurality of forward blade segments to form a plurality of contiguous blade structures, which extend from a forward portion of the inducer hub to an aft portion of the exducer hub.

### STATEMENT REGARDING FEDERALLY SPONSORED RESEARCH OR DEVELOPMENT

This invention was made with Government support under DTFAWA-10-C-00040 awarded by the FAA. The Government has certain rights in this invention.

### TECHNICAL FIELD

The present invention relates generally to gas turbine engines and, more particularly, to embodiments of a multi-piece centrifugal impeller, as well as to methods for manufacturing multi-piece centrifugal impellers.

### BACKGROUND

Many gas turbine engine platforms include a centrifugal compressor or “impeller” positioned upstream of the engine's combustion section. A centrifugal impeller typically includes an annular hub and a plurality of blades, which extend outward from the annular hub and which wrap tangentially around the hub in a twisting or spiral pattern. The impeller blades serve as airfoils and, during rotation of the impeller, force high pressure airflow from the impeller's forward or inducer portion to the impeller's aft or exducer portion. As airflow travels from the inducer portion to the exducer portion under the influence of centrifugal forces, the air is compressed and its pressure increased. Hot, compressed airflow is expelled by the impeller's exducer portion and directed into the gas turbine engine's combustion section, mixed with fuel, and ignited to produce combustive gases. The combustive gases flow through one or more air turbines downstream of the combustion section to produce power and to drive further rotation of the centrifugal impeller. After flowing through the air turbine section, the combustive gas flow is exhausted from the gas turbine engine to produce forward thrust.

As the pressure of the air flowing from the impeller's inducer portion to the impeller's exducer portion increases, so too does the temperature of the airflow. The temperature of the air flowing over the impeller may be especially elevated in gas turbine engine platforms employing multiple axial compressor stages upstream of the impeller, which compress and thus pre-heat the airflow prior to contact with the impeller to improve compression system pressure ratios and other measures of engine performance (e.g., specific fuel consumption and power density). To withstand this higher temperature, the size of the impeller annular hub (or disk) can be increased; however, this results in impeller hubs that are relatively bulky and heavy. Alternatively, the impeller can be fabricated from a relatively heavy metal or alloy having higher temperature capabilities (e.g., a nickel-based superalloy) as compared the lighter weight metals or alloys (e.g., titanium alloys) typically employed in impeller fabrication. However, this again results in an undesirable increase in the overall impeller weight.

It would thus be desirable to provide embodiments of a centrifugal impeller having increased thermal capabilities, a reduced weight, and/or other desirable properties as compared to conventionally-known impellers of the type described above. It would also be desirable to provide embodiments of a method for manufacturing such an improved centrifugal impeller. Other desirable features and characteristics of the present invention will become apparent from the subsequent Detailed Description and the appended Claims, taken in conjunction with the accompanying Drawings and the foregoing Background.

### BRIEF SUMMARY

Embodiments of a multi-piece centrifugal impeller are provided. In one embodiment, the multi-piece centrifugal impeller includes an inducer piece and an exducer piece. The inducer piece includes, in turn, an inducer hub and a plurality of forward blade segments, which extend radially outward from the inducer hub. The exducer piece includes an exducer hub, which is positioned axially adjacent the inducer hub, and a plurality of aft blade segments, which extend outward from the exducer hub. The plurality of aft blade segments interlock with the plurality of forward blade segments to form a plurality of contiguous blade structures, which extend from a forward portion of the inducer hub to an aft portion of the exducer hub.

In further embodiments, the multi-piece centrifugal impeller includes an inducer piece and an exducer piece, which are fabricated from different materials. The inducer piece includes, in turn, an inducer hub and a plurality of forward blade segments, which extend radially outward from the inducer hub. The exducer piece includes an exducer hub, which is positioned axially adjacent the inducer hub, and a plurality of aft blade segments, which extend outward from the exducer hub. The plurality of aft blade segments align with the plurality of forward blade segments.

Embodiments of a method for manufacturing a multi-piece centrifugal impeller are further provided. In one embodiment, the method includes the steps of fabricating an inducer piece having an inducer hub and a plurality of forward blade segments extending radially therefrom, producing an exducer piece having an exducer hub and a plurality of aft blade segments extending outward therefrom, and assembling the inducer piece and the exducer piece such that the inducer hub and the exducer hub align to form a contiguous hub flowpath and the plurality of aft blade segments interlocks with the plurality of forward blade segments to form a plurality of contiguous blade structures extending from a forward portion of the inducer hub to an aft portion of the exducer hub.

### BRIEF DESCRIPTION OF THE DRAWINGS

At least one example of the present invention will hereinafter be described in conjunction with the following figures, wherein like numerals denote like elements, and:

FIG. 1 is a schematic illustrating an exemplary gas turbine engine (partially shown) including a low pressure compressor section, a high pressure compressor section, a combustion section, and a turbine section;

FIG. 2 is an isometric view of an interlocking multi-piece impeller included within the high pressure compressor section of the gas turbine engine shown in FIG. 1 and illustrated in accordance with an exemplary embodiment of the present invention;

FIG. 3 is a top-down view of an outer portion of a forward blade segment and a neighboring aft blade segment included within the interlocking multi-piece impeller shown in FIG. 2;

FIGS. 4 and 5 are side plan and isometric views, respectively, of a portion of the exemplary multi-piece centrifugal impeller shown in FIG. 2 illustrating one possible joinder interface between the impeller's inducer hub and the impeller's exducer hub;

FIG. 6 is a side plan view of a portion of an exemplary multi-piece centrifugal impeller illustrating a second exemplary joinder interface between the impeller's inducer hub and the impeller's exducer hub; and

FIGS. 7-12 are top-down views illustrating several exemplary manners in which a given aft blade segment included within the exemplary centrifugal impeller shown in FIGS. 2, 4, and 5 may interlock with its neighboring forward blade segment to form a continuous impeller blade structure.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description.

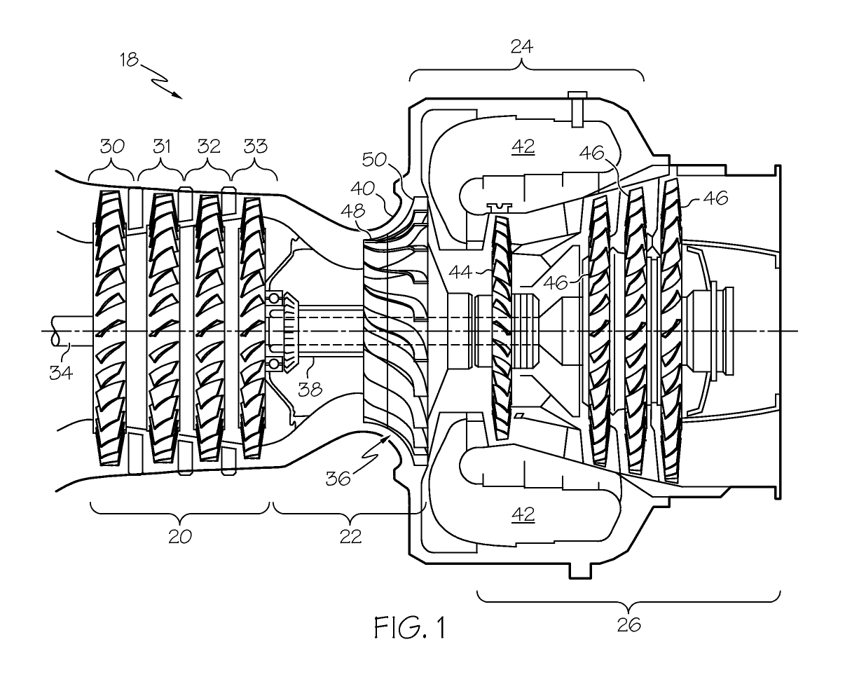

FIG. 1 is a generalized schematic of a portion of a gas turbine engine (GTE) 18 including a low pressure compressor section 20, a high pressure compressor section 22, a combustion section 24, and a turbine section 26. In this particular example, low pressure compressor section 20 includes a plurality of axial compressor stages 30-33, which each include an axial compressor mounted to a low pressure (LP) spool or shaft 34. High pressure compressor section 22 is positioned immediately downstream of low pressure compressor section 20 and includes a single centrifugal compressor or impeller 36. Centrifugal impeller 36 is mounted to a high pressure (HP) shaft 38, which is co-axial with LP shaft 34 and through which LP shaft 34 extends. A shroud 40 encloses impeller 36 to guide a airflow exhausted by impeller 36 into combustion section 24. Combustion section 24 includes at least one combustor 42 having an outlet nozzle, which directs combustive gas flow into turbine section 26. More specifically, the outlet nozzle of combustor 42 directs combustive gas flow from combustion section 24, through a high pressure turbine 44 mounted to HP shaft 38, and subsequently through a series of low pressure turbines 46 mounted to LP shaft 34. Although not illustrated in FIG. 1 for clarity, GTE 18 further includes additional sections, such as an intake section (e.g., a fan module) upstream of compressor section 20 and an exhaust section downstream of turbine section 24.

During GTE operation, the axial compressors within compressor stages 30-33 rotate in conjunction with LP shaft 34 to compress airflow received from the intake section of GTE 18. The compressed airflow is supplied to high pressure compressor stage 22 and further compressed by impeller 36, which rotates in conjunction with HP shaft 38. The compressed, hot airflow is then directed into combustion chamber 42, mixed with fuel, and ignited. The air heats rapidly, expands, and flows from combustor chamber 42 and into the inlet of high pressure turbine 44. The combustive gas flow drives the rotation of turbine 44 and, therefore, the rotation of HP shaft 38 and impeller 36. After being exhausted from high pressure turbine 44, the combustive gases flow through low pressure turbines 46 to drive the rotation of turbines 46 and, therefore, the rotation of LP shaft 34 and the axial compressors within compressor stages 30-33. Finally, the air is expelled through the gas turbine engine's exhaust section to produce forward thrust. The power output of GTE 18 may be utilized in a variety of different manners, depending upon whether GTE 18 assumes the form of a turbofan, turboprop, turboshaft, or turbojet engine.

In accordance with embodiments of the present invention, impeller 36 is assembled from at least two discrete components or pieces. With reference to the exemplary embodiment illustrated in FIG. 1, specifically, impeller 36 is assembled from a forward inducer piece 48 and an aft exducer piece 50. By virtue of such a multi-piece construction, the different sections of impeller 36 can be fabricated from different materials tailored to the disparate operating conditions experienced by the aft and fore sections of impeller 36 during operation. For example, as the temperatures to which exducer piece 50 is exposed will typically be significantly higher than the temperatures to which inducer piece 48 is exposed, exducer piece 50 may be fabricated from a metal or alloy, such as a nickel-based superalloy, having a relatively high density and thermal tolerance. In contrast, inducer piece 48 may be fabricated from a metal or alloy having a lower thermal tolerance (e.g., a titanium-based superalloy) and a lower density. In this manner, the temperature capabilities of impeller 36 can be maximized to boost overall compression system pressure ratios and thereby improve various measures of engine performance (e.g., specific fuel consumption and power density), while the overall weight of impeller 36 is reduced as compared a monolithic or single piece impeller fabricated entirely from a heavier superalloy having higher thermal tolerances.

Criteria other than relative densities and thermal tolerances may be utilized to select the material or materials from which inducer piece 48 and exducer piece 50 are fabricated. For example, as mechanical stress arising from centrifugal forces will typically concentrate in exducer piece 50, exducer piece 50 may be fabricated from a material having a relatively high mechanical strength to decrease the likelihood of crack formation and propagation, and improve creep resistance, during high speed operation of impeller 36. As a further example, in cases wherein the leading edges of inducer piece 48 may be impacted by sand, ice, or other abrasive foreign object debris carried by the air taken into GTE 18 (e.g., as in cases wherein GTE 18 is to be utilized within a desert environment), inducer piece 48 may be produced from a material having a relatively high erosion tolerance. By comparison, exducer piece 50, which is generally shielded from direct contact with such abrasive debris, may be fabricated from a material less resistant to erosion and, instead, having other desirable properties; e.g., if weight savings are desired, exducer piece 50 may be fabricated from a relatively lightweight metal or alloy (e.g., a titanium based superalloy), or, if higher thermal capabilities are desired, exducer piece 50 may be fabricated from a heavier metal or alloy having higher thermal tolerances (e.g., a nickel-based superalloy). As another example, inducer and exducer pieces 48 and 50 may be fabricated from the same or similar alloy, but subjected to different process steps (forged and/or heat treated differently) to tailor material properties (e.g., grain sizes) to the particular conditions to which the individual pieces are subjected. The foregoing examples notwithstanding, it is emphasized that inducer piece 48 and exducer piece 50 need not be fabricated from different materials in all embodiments. As will be described more fully below, embodiments of multi-piece centrifugal impeller 36 enable material to be removed from within the impeller's interior to reduce overall impeller weight, while maintaining the structure integrity thereof; consequently, embodiments of multi-piece impeller 36 can be advantageous even when inducer piece 48 and exducer piece 50 are fabricated from the same or similar materials.

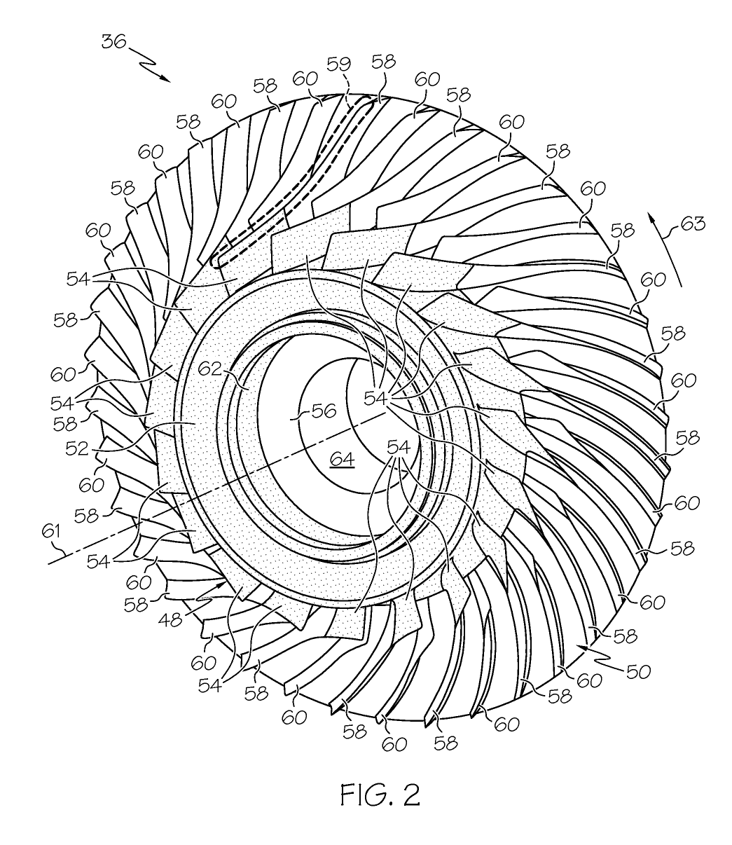

FIG. 2 is an isometric view of multi-piece centrifugal impeller 36 illustrated in accordance with an exemplary embodiment of the present invention. As can be seen in FIG. 2, inducer piece 48 includes an inducer hub 52 and a plurality of forward blade segments 54, which extend radially outward from inducer hub 52 and which wrap or twist around the longitudinal axis of hub 52 in a spiral pattern. Inducer hub 52 and exducer hub 56 assume the form of generally annular bodies having central openings 62 and 64 therein, respectively. In the illustrated example, the inner diameter of central opening 62 provided through inducer hub 52 is greater than the inner diameter of central opening 64 provided through exducer hub 56. When multi-piece centrifugal impeller 36 is assembled, inducer hub 52 aligns axially with exducer hub 56 and, preferably, radially pilots thereto. In this manner, hubs 52 and 56 combine to form a substantially co-axial hub assembly when impeller 36 is assembled. Central openings 62 and 64 likewise align when impeller 36 is assembled to define a longitudinal channel through impeller 36. When impeller 36 is installed within GTE 18 (FIG. 1), a spool (e.g., high pressure shaft 38 of GTE 18) extends through this longitudinal channel. Impeller 36, and specifically exducer hub 56, is fixedly mounted to the gas turbine engine spool utilizing, for example, a curvic-type attachment.

Forward blade segments 54 are circumferentially spaced around inducer hub 52 and extend from approximately the leading face of inducer hub 52 to the trailing face thereof or, more generally, from approximately the leading circumferential edge of impeller 36 to a mid-section thereof. Similarly, exducer piece 50 includes an exducer hub 56 and a plurality of aft blade segments 58, which extend outward from exducer hub 56 in a direction substantially normal to the hub surface and which wrap tangentially around hub 56. In certain embodiments, exducer piece 50 may further include a plurality of truncated aft blades 60, commonly referred to as “splitter blades,” which are circumferentially interspersed with aft blade segments 58 and which are similar thereto; e.g., as do aft blade segments 58, truncated aft blades 60 extend outward from exducer hub 56 and wrap tangentially around hub 56. Aft blade segments 58 and truncated aft blades 60 are likewise circumferentially spaced around inducer hub 52 and extend from approximately the leading face of exducer hub 56 to the trailing face thereof or, more generally, from approximately a mid-section of impeller 36 to the trailing circumferential edge thereof. Inducer piece 48 and exducer piece 50 are each preferably integrally formed as a single machined piece or bladed disc (commonly referred to as a “blisk”).

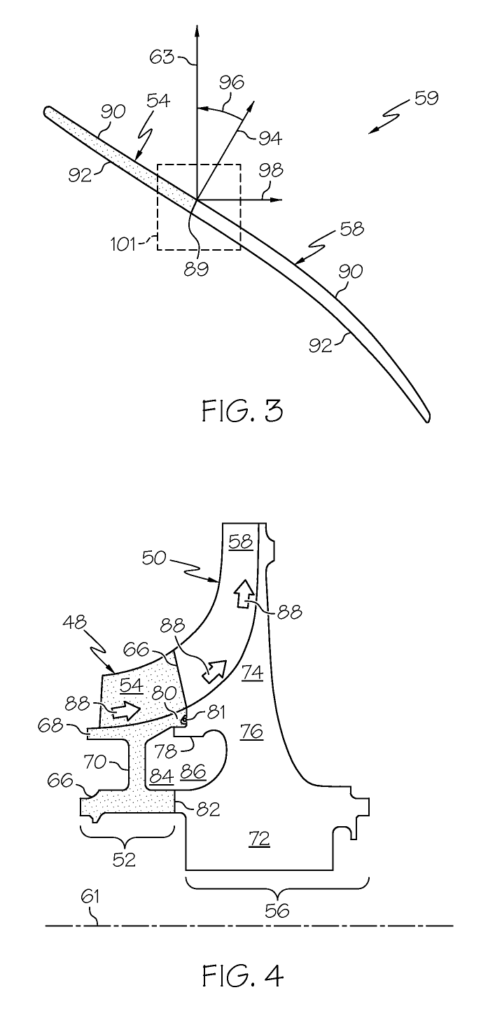

FIG. 3 is a top-down view of an outer ridge portion 59 (identified in FIG. 2) of a forward blade segment 54 and an aft blade segment 58 of multi-piece impeller 36. During operation of GTE 18 and rotation of impeller 36, inducer piece 48 and exducer piece 50 rotate jointly as a single body about the longitudinal axis or centerline of impeller 36 (represented in FIG. 2 by dashed line 61) in a predetermined rotational direction (indicated in FIGS. 2 and 3 by arrow 63). The faces of forward blade segments 54 and aft blade segments 58, which spin into the compressed airflow during rotation of impeller 36 are commonly referred to as “pressure surfaces” and are identified in FIG. 3 at 90. Conversely, the opposing faces of forward blade segments 54 and aft blade segments 58, which spin away from the compressed airflow during impeller rotation, are commonly referred to as “suction surfaces” and are identified in FIG. 3 at 92. The axial direction and the blade surface normal at the blade segment joint 89 are represented in FIG. 3 by arrows 98 and 94, respectively. The angle formed by the direction of rotation 63 and the blade surface normal 94 is commonly referred to as the “blade angle” and is identified in FIG. 3 by arrow 96.

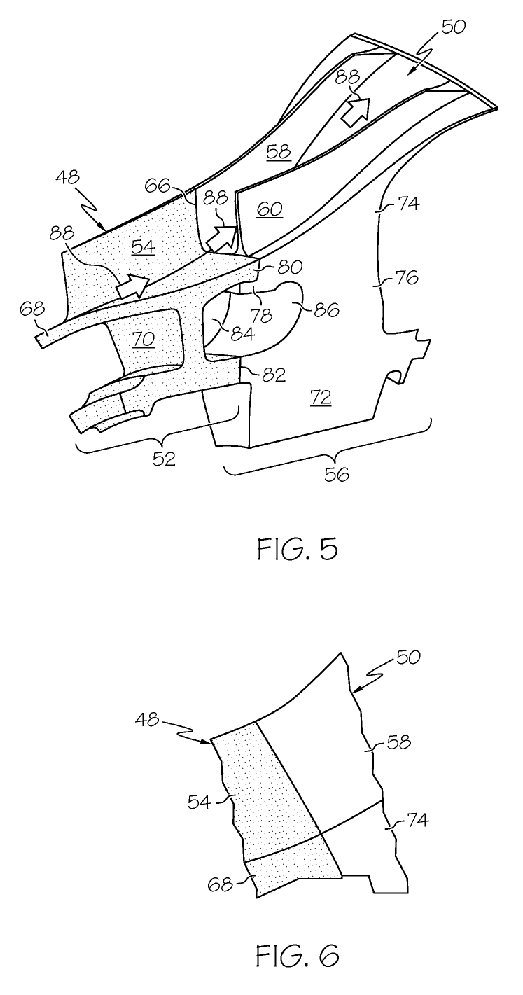

FIGS. 4 and 5 are side plan and isometric views, respectively, illustrating a portion of interlocking multi-piece centrifugal impeller 36 in greater detail. It can be seen in FIGS. 4 and 5 that inducer hub 52 includes an inner annular region 66 (referred to herein as “forward rotor disc 66”), an outer annular region 68 from which forward blade segments 54 extend, and an annular connecting wall 70, which extends radially outward from forward rotor disc 66 to outer annular region 68 of inducer hub 52. In a similar manner, exducer hub 56 includes an inner annular region 72 (referred to herein as “aft rotor disc 72”), an outer annular region 74 from which aft blade segments 58 and truncated aft blades 60 extend, and an annular connecting wall 76, which extends radially outward from aft rotor disc 72 to outer annular region 74 of exducer hub 56. In preferred embodiments, a radially-overlapping hub interface (e.g., an annular lap joint) is provided between inducer hub 52 and exducer hub 56 to radially pilot hub 52 to hub 56 when impeller 36 is assembled. In this regard, and as shown in FIGS. 4 and 5, exducer hub 56 may be fabricated to include an annular step or shelf 78, which extends outwardly from hub 56 in an axial direction toward inducer piece 48. Annular shelf 78 is matingly engaged about its outer circumference by a trailing lip or rim 80 extending axially from outer annular region 68 of inducer hub 52 toward exducer piece 50. In this manner, inducer hub 52 positively registers to exducer hub 56 to ensure proper radial alignment and, specifically, to ensure that hubs 52 and 56 are substantially co-axial. As a result, the formation of discontinuities (e.g., steps) is avoided between the outer circumferential surfaces of hubs 52 and 56 defining the hub flow paths and between the outer ridges or tips of forward and aft blade segments 54 and 58. Finally, as further shown in FIGS. 4 and 5 at 82, the trailing radial face of forward rotor disc 66 may abut the leading radial face of aft rotor disc 68 to provide additional mechanical support.

Other types of radially-overlapping joints may be formed between inducer hub 52 and exducer hub 56 in further implementations of impeller 36. For example, as shown in FIG. 6, outer annular region 68 of inducer hub 52 and outer annular region 74 of exducer hub 56 may matingly engage along a conical interface, which, in the illustrated example, decreases in diameter when moving in a fore-aft direction. Regardless of the particular form assumed by the radially-overlapping joint between inducer hub 52 and exducer hub 56, or its particular location, it is preferred that the joint is designed such that inducer hub 52 grows into exducer hub 56 and/or exducer hub 56 grows into inducer hub 52 to yield an essentially continuous hub flowpath across the joint when subject to thermal expansion and centrifugal loads during operation of impeller 36. If desired, a wire seal or other sealing element can be disposed within the radially-overlapping hub interface to further reduce or eliminate leakage of airflow between inducer hub 52 and exducer hub 56. For example, as shown in FIG. 4 at 81, a wire seal may be disposed within an annular groove provided in the outer circumferential surface of annular shelf 78 and sealingly compressed between trailing rim 80 and shelf 78 to minimize or prevent leakage between inducer hub 52 and exducer hub 56.

Advantageously, the multi-piece construction of impeller 36 enables material to be strategically removed from the interior of inducer piece 48 and/or exducer piece 50 prior to impeller assembly to allow the creation of one or more voids within impeller 36 and thereby reduce overall impeller weight. For example, as indicated in FIGS. 4 and 5, material may be removed from the back or trailing face of inducer piece 48 to form a first annular cavity or groove 84 therein. Similarly, material may be removed from the front or leading face of exducer piece 50 to form a first annular cavity or groove 86 therein. When multi-piece centrifugal impeller 36 is assembled, the trailing face of inducer piece 48 is positioned adjacent the leading face of exducer piece 50, and grooves 84 and 86 cooperate to define an annular void 84, 86 within impeller 36. In the illustrated example, inner annular void 84, 86 is located between connecting walls 70 and 76, as taken in an axial direction. Inner annular void 84, 86 is fully contained within impeller 36 and does not breach either connecting wall 70 or connecting wall 76; consequently, the provision of annular void 84, 86 has minimal impact on the overall structural integrity of impeller 36.

When multi-piece centrifugal impeller 36 is assembled, forward blade segments 54 may align axially and tangentially with aft blade segments 58. Forward blade segments 54 and aft blade segments 58 may or may not join in an interlocking relationship. In either case, axial and tangential alignment of the non-interlocking blade segments may be maintained by press-fitting of annular shelf 78 of exducer piece 50 onto trailing rim 80 of inducer piece 48; that is, trailing rim 80 of inducer piece 48 may exert a sufficient circumferential clamping force on annular shelf 78 of exducer piece 50 to prevent relative rotational movement of inducer piece 48 and exducer piece 50 during operation of impeller 36. Axial alignment of forward blade segments 54 and aft blade segments 58 may also be maintained by an axial clamping force or pre-load exerted on centrifugal impeller 36 by a tie-shaft (not shown). Additionally, the mating interface between trailing rim 80 and annular shelf 78 may be fabricated to include one or more alignment features (e.g., keys, teeth, or castellations) that provide tangential alignment between inducer piece 48 and exducer piece 50 when impeller 36 is assembled.

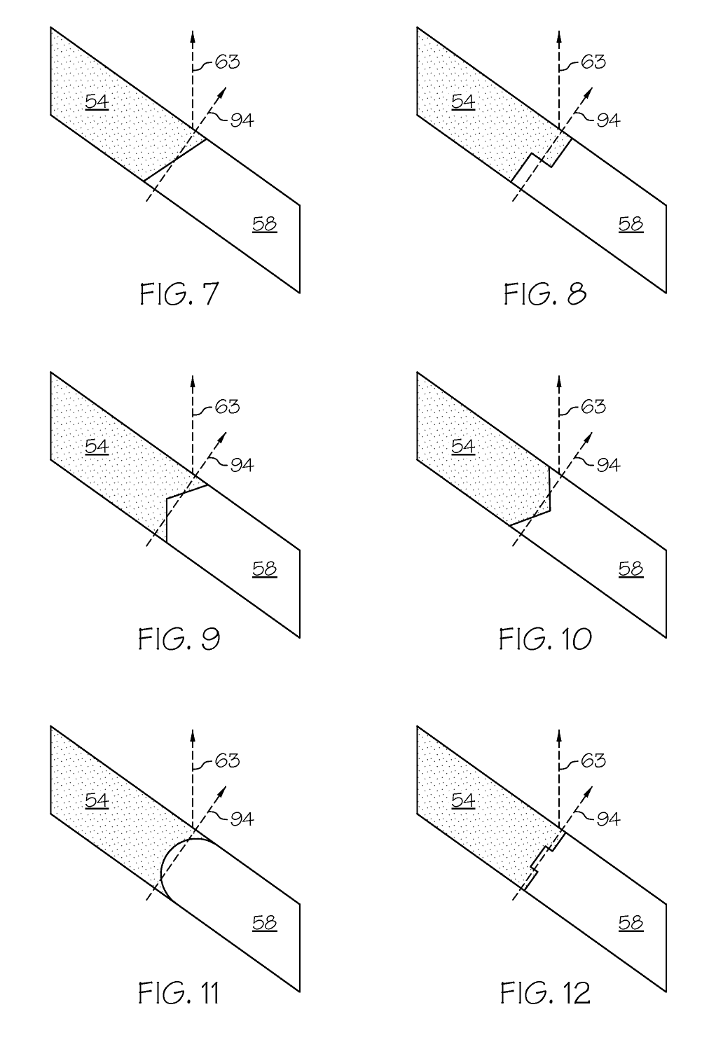

In further embodiments of impeller 36, neighboring pairs of forward blade segments 54 and aft blade segments 58 interlock to form to form a plurality of contiguous impeller blade structures 54, 58, which extend from approximately the leading circumferential edge of impeller 36 to the trialing circumferential edge thereof. Interlocking of the blade segments may occur during non-operation and operation of impeller 36 or solely during operation of impeller 36 when centrifugal forces are applied to blade segments 54 and 58; in either case, the blade segments are considered “interlocking” in the context of the present application. The dimensions (e.g., the widths and heights) and surface contours of forward blade segments 54 and aft blade segments 58 are preferably substantially identical at the interlocking interface to provide a continuous or uninterrupted transition between blade segment surfaces, and specifically between pressure faces 90 and suction faces 92 of impeller blade structures 54, 58 (FIG. 3), to minimize airflow leakage. As a result of this structural configuration, multi-piece impeller 36 provides substantially uninterrupted airflow guidance surfaces along the blade passage and, specifically, when transitioning from inducer piece 48 to the exducer piece 50, to minimize leakage of the compressed airflow between pieces 48 and 50 (represented in FIGS. 4 and 5 by arrows 88). In so doing, multi-piece centrifugal impeller 36 achieves aerodynamic performance levels substantially equivalent to that provided by an impeller having a unitary or monolithic construction. Several exemplary manners in which forward blade segments 54 may interlock with aft blade segments 58, and the benefits provided by such an interlocking interface, are described more fully below in conjunction with FIGS. 7-12.

FIGS. 7-12 are top-down views illustrating several exemplary manners in which a forward blade segment 54 included within impeller 36 may interlock with a corresponding aft blade segment 58. As indicated in FIG. 3 by dashed box 101, only a portion of each forward and aft blade segment is illustrated in FIGS. 7-12 for clarity. Referring collectively to FIGS. 7-12, the illustrated forward blade segment 54 may interlock with aft blade segment 58 along a slanted interface (FIG. 7), a shiplap joint interface (FIG. 8), a chevron interface (FIGS. 9 and 10), a concave/convex interface (FIG. 11), or a tongue-in-groove or saw-tooth interface (FIG. 12). In each of these exemplary cases, the aft or trailing end portion of forward blade segment 54 overlaps with the forward or leading end portion of aft blade segment 58 in a direction substantially parallel with the blade surface normal 94 at the interlocking interface (note also that the slanted interface shown in FIG. 7 is slanted with respect to the blade surface normal 94). The overlapping joints shown in FIGS. 7 and 8 prevent relative movement between forward blade segment 54 and aft blade segment 58 in one direction along the blade surface normal 94, which prevents rotational misalignment of inducer piece 48 and exducer piece 50 during rotation of centrifugal impeller 36 (FIGS. 1-4). By comparison, the overlapping joints shown in FIGS. 9-12 prevent relative movement between forward blade segment 54 and aft blade segment 58 in opposing directions along the blade surface normal 94. With respect to FIG. 12, it is noted that that the dimensions of the tooth may remain constant or may vary from hub to tip; e.g., the tooth width may vary proportional to the blade section thickness.

With continued reference to FIGS. 7-12, each of the illustrated tangentially-overlapping joints includes an axial depression, which is formed in either blade segment 54 or blade segment 58, and axial extension, which is formed in either forward blade segment 54 or aft blade segment 58 and which is matingly inserted into the axial depression during assembly. In the case of each of the tangentially-overlapping joints shown in FIGS. 9-12, the axial depression assumes the form of a radial slot within which the axial extension is matingly received. The illustrated joints thus enable each forward blade segment 54 to be inserted into its corresponding aft blade segment 58 in an axial direction during impeller assembly. Although not shown in FIGS. 7-12 for clarity, a sealing element can be disposed within the interlocking interface formed by neighboring blade segments to prevent or minimize leakage; e.g., in one embodiment, the trailing end portion of forward blade segments 54 and/or the leading end portion of aft blade segments 58 may have a compliant coating formed thereon, which compresses when blade segments 54 and 58 interlock to form an airtight seal. To further support or maintain such an interlocking relationship between forward blade segments 54 and aft blade segments 58, a tie-shaft pre-load to provide an axial clamping force and centrifugal loads that occur during engine operation. If desired, additional features may be provided to enhance sealing at through the interlocking interface. For example, the interface may be sealed by compressing a sealing wire or ribbon between blade segments 54 and 58. In this case, the sealing wire or ribbon may be solid or hollow and fabricated from an annealed material, such as aluminum, copper, nickel, or other suitably ductile alloy.

It should thus be appreciated that, in exemplary embodiments shown in FIGS. 7-12, the mechanism that aligns the forward blade segments 54 and the aft blade segments 58 is interlocking; that is, each forward blade segment 54 cooperates or combines with its neighboring aft blade segment 58 to form an overlapping joint that prevents relative movement of the neighboring blade segments in the blade surface normal direction 94 at least during operational of impeller 36 and possibly also during non-operation/assembly of impeller 36. Interlocking constrains the overlapping joint in the axial direction and tangential direction so that relative motion in the blade surface normal direction 94 is constrained during impeller operation. When multi-piece centrifugal impeller 36 is installed within a gas turbine engine, such as GTE 18 shown in FIG. 1, the interlocking relationship between forward blade segments 54 and aft blade segments 58 is maintained by centrifugal loads that occur during engine operation and/or an axial clamping force exerted on impeller 36 by, for example, a tie-shaft pre-load. With respect to the exemplary embodiments shown in FIGS. 7 and 8, specifically, blade segments 54 and 58 may be slightly offset or non-contacting prior to impeller operation; however, during impeller operation, centrifugal loads and/or an axial clamping forces may cause blade segments 54 and 58 to move into the illustrated interlocking relationship and thereby provide blade segment alignment and minimize leakage paths through impeller 36. By comparison, in the exemplary embodiments shown in FIGS. 9-12, forward blade segments 54 and aft blade segments 58 are physically maintained in an interlocking relationship regardless of whether impeller 36 is or is not operational. Additionally, it should be appreciated that, in the exemplary embodiment shown in FIG. 4, forward disk 52 and aft disk 56 are also aligned by cooperation of the multi-piece disks so that at the joint between forward disk 52 and aft disk 56, and especially at the flowpath interface, the disks are axially and radially aligned (i.e., relative rolling of the disks and flowpath steps are minimized) when clamped with a tie-shaft load and operating at design thermal and centrifugal loads.

There has thus been provided multiple embodiments of a multi-piece centrifugal impeller that allows different sections of the impeller to be fabricated from disparate materials, while reducing or eliminating leakage paths through the impeller, while reliably maintaining alignment between neighboring blade segments, and while providing substantially uninterrupted airflow guidance surfaces when transitioning from the impeller's inducer portion to the impeller's exducer portion to optimize overall impeller performance. The foregoing description has also provided embodiments of a method for manufacturing such a multi-piece centrifugal impeller. In one embodiment, the method includes the steps of: (i) fabricating an inducer piece having an inducer hub and a plurality of forward blade segments extending radially from the inducer hub, (ii) producing an exducer piece having an exducer hub and a plurality of aft blade segments, which extending outward from the exducer hub and are configured to interlock with the plurality of forward blade segment, and (iii) joining the inducer piece to the exducer piece such that the inducer hub and the exducer hub align to form a contiguous hub flowpath and such that each of the plurality of forward blade segments tangentially interlock with a different one of the plurality of aft blade segments.

While multiple exemplary embodiments have been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended Claims.

What is claimed is:

1. A multi-piece centrifugal impeller, comprising:
an inducer piece, comprising:
an inducer hub; and
a plurality of forward blade segments extending radially outward from the inducer hub;
an exducer piece, comprising:
an exducer hub axially adjacent the inducer hub; and
a plurality of aft blade segments extending outward from the exducer hub and interlocking with the plurality of forward blade segments to form a plurality of contiguous blade structures extending from a forward portion of the inducer hub to an aft portion of the exducer hub.

2. A multi-piece centrifugal impeller according to claim 1 wherein each contiguous blade structure comprises an overlapping joint formed by the forward blade segment and the aft blade segment included within the contiguous blade structure.

3. A multi-piece centrifugal impeller according to claim 2 wherein each contiguous blade structure defines a pressure surface, and wherein the overlapping joint prevents relative movement between the forward blade segment and the aft blade segment included within the contiguous blade structure in a direction substantially normal to the pressure surface at the overlapping joint.

4. A multi-piece centrifugal impeller according to claim 3 wherein each overlapping joint comprises:
an axial depression formed in one of the aft blade segment and the forward blade segment included within the contiguous blade structure; and
an axial extension formed in the other of the aft blade segment and the forward blade segment included within the contiguous blade structure, the axial extension matingly received by the axial depression.

5. A multi-piece centrifugal impeller according to claim 1 wherein the inducer hub radially pilots to the exducer hub to maintain the inducer hub and the exducer hub in a substantially co-axial relationship.

6. A multi-piece centrifugal impeller according to claim 1 further comprising a radially-overlapping joint formed between the inducer hub and the exducer hub.

7. A multi-piece centrifugal impeller according to claim 6 wherein the radially-overlapping joint comprises an annular shelf extending axially from the exducer hub in an aft direction to matingly engage the inducer hub.

8. A multi-piece centrifugal impeller according to claim 7 wherein the inducer hub includes a trailing rim portion circumferentially engaging the annular shelf.

9. A multi-piece centrifugal impeller according to claim 1 further an inner annular void formed within the multi-piece impeller.

10. A multi-piece centrifugal impeller according to claim 9 wherein inducer hub has a trailing radial face, and wherein the exducer hub has a leading radial face positioned adjacent the trailing radial face.

11. A multi-piece centrifugal impeller according to claim 10 wherein the inner annular void comprises at least one of the group consisting of:
a first annular groove formed in the trailing face of the inducer piece; and
a second annular groove formed in the leading face of the exducer piece.

12. A multi-piece centrifugal impeller according to claim 1 wherein the inducer piece and exducer piece are fabricated from different materials, and wherein the material from which the exducer piece is fabricated has a higher temperature tolerance than does the material from which the inducer piece is fabricated.

13. A multi-piece centrifugal impeller according to claim 1 wherein the inducer piece and exducer piece are fabricated from different materials, and wherein the material from which the inducer piece is fabricated has a higher erosion resistance than does the material from which the exducer piece is fabricated.

14. A multi-piece centrifugal impeller, comprising:
an inducer piece, comprising:
an inducer hub; and
a plurality of forward blade segments extending radially outward from the inducer hub;
an exducer piece, comprising:
an exducer hub positioned axially adjacent the inducer hub; and
a plurality of aft blade segments extending outward from the exducer hub and aligning with the plurality of forward blade segments, the exducer piece and the inducer piece fabricated from different materials.

15. A multi-piece centrifugal impeller according to claim 14 wherein the material from which the exducer piece is fabricated has a higher temperature tolerance than does the material from which the inducer piece is fabricated.

16. A multi-piece centrifugal impeller according to claim 14 the material from which the inducer piece is fabricated has a higher erosion resistance than does the material from which the exducer piece is fabricated.

17. A method for manufacturing a multi-piece centrifugal impeller, comprising:
fabricating an inducer piece having an inducer hub and a plurality of forward blade segments extending radially therefrom;
producing an exducer piece having an exducer hub and a plurality of aft blade segments extending therefrom; and
assembling the inducer piece and the exducer piece such that the inducer hub and the exducer hub align to form a contiguous flow path and such that the plurality of forward blade segments interlocks with the plurality of aft blade segments to form a plurality of contiguous blade structures extending from a forward portion of the inducer hub to an aft portion of the exducer hub.

18. A method according to claim 17 wherein the step of fabricating comprises fabricating the inducer piece from a first alloy, wherein the step of producing comprises producing the exducer piece from a second alloy having a metallurgical composition substantially identical to that of the first alloy.

19. A method according to claim 18 further comprises the step of subjecting the inducer piece and the exducer piece to different heat treatment processes to impart the inducer piece and exducer with different material properties.

20. A method according to claim 17 wherein the inducer piece has a trailing radial face, wherein the exducer piece has a leading radial face, and wherein the method further comprises at least step selected from group consisting of:
removing material from the inducer piece through the trailing radial face prior to assembling the multi-piece centrifugal impeller; and
removing material from the exducer piece through the leading radial face prior to assembling the multi-piece centrifugal impeller.
